(19) United States
(12) Patent Application Publication
(10) Pub. No.: US 2024/0378503 A1
(43) Pub. Date: Nov. 14, 2024

(54) GENERATING SYNTHETIC TRAINING DATA

(71) Applicant: BAYER AKTIENGESELLSCHAFT, Leverkusen (DE)

(72) Inventors: Javier MONTALT, Valencia (ES); Guillem DURAN, Palma de Mallorca (ES); Seyed Sadegh MOHAMMADI, Cologne (DE); Pedro LOURO COSTA OSORIO, Castelldefels (ES); Shivam Shivkumar Sunita SINGH, Madgeburg (DE); Jens HOOGE, Berlin (DE)

(21) Appl. No.: 18/656,211

(22) Filed: May 6, 2024

(30) Foreign Application Priority Data
May 12, 2023 (EP) 23172995.5

(51) Int. Cl. G06N 20/00

(52) U.S. Cl. CPC G06N 20/00

(57) ABSTRACT

Systems, methods, and computer programs disclosed herein relate to generating synthetic training data for training machine learning models.

### CROSS-REFERENCE TO RELATED APPLICATIONS

This application claims priority to European Patent Application No. 23172995.5, filed May 12, 2023, the entire content of which is incorporated herein by reference in its entirety.

### FIELD OF THE DISCLOSURE

Systems, methods, and computer programs disclosed herein relate to generating synthetic training data for training machine learning models.

### BACKGROUND

Artificial intelligence is spreading rapidly in the healthcare field. Machine learning models are being used to diagnose diseases (see, e.g., WO 2018/202541 A1), detect and identify tumor tissue (see, e.g., WO 2020/229152 A1), reduce the amount of contrast media used in radiological examinations (see, e.g., WO 2022/184297 A1), and speed up radiological examinations (see, e.g., WO 2021/052896 A1). Chambon, P., et al. disclose methods of generating synthetic radiologic images using machine learning models (Chambon, P., et al.: Vision-Language Foundation Model for Chest X-ray Generation, 2022, arXiv:2211.12737v1; Chambon, P., et al.: Adapting Pretrained Vision-Language Foundational Models to Medical Imaging Domains, 2022, arXiv:2210.04133v1).

For the development of machine learning models, training data is needed to train the models for the described tasks and/or additional/different tasks. The quality and performance of a machine learning model is often determined by the training data. For example, models are often limited by the corresponding training data; and models are also often limited in what they may accurately predict by what they have been taught by means of the training data.

There are a number of issues that may complicate the provision of training data in the healthcare field. Providing training data for machine learning models in healthcare often requires studies on healthy people and on patients suffering from a disease; such studies may be expensive and time-consuming. Medical image data in particular is often expensive and/or complex to generate. Since patient data is personal data, high legal requirements may apply in the area of data protection; for example, patients must consent to the use of their data to train machine learning models. Patient data are often not balanced; patient data are often not representative of all populations; there may be a risk of bias. Finally, there is often too little data available, especially for rare diseases.

A commonly used technique to increase the size of a training dataset is data augmentation. In image augmentation, modifications of the available images are generated. However, the amount of variation in training data that can be achieved through augmentation is limited. Furthermore, modifications of medical images are still images that can be associated with a subject and are therefore subject to privacy protection.

So, there is a need for data that can be used to train machine learning models. It would be desirable to have training data that on the one hand reflects reality, but on the other hand is not subject to data privacy restrictions. It would be desirable to have sufficient data available at any time and any place to train machine learning models.

### SUMMARY

These problems are addressed by the subject matter of the present disclosure.

In a first aspect, the present disclosure relates to a computer-implemented method for generating a synthetic image dataset for training a machine learning model, the method comprising the steps:
receiving a set of class-labelled medical images,
clustering the class-labelled medical images into a number of clusters according to morphological, structural, and/or textural aspects,
determining a color scheme from each medical image,
generating a text for each medical image, wherein the text of each medical image comprises:
   the class-label of the medical image,
   the color scheme of the medical image, and
   a cluster index, wherein the cluster index indicates which cluster the medical image was assigned to,
generating a first training dataset based on the medical images and the texts,
training a text-to-image model on the first training dataset to generate synthetic medical images based on text prompts,
generating a second training dataset using the trained machine learning model, and
outputting the second training dataset.

In another aspect, the present disclosure provides a computer system comprising:
a processor; and
a memory storing an application program configured to perform, when executed by the processor, an operation, the operation comprising:
   receiving a set of class-labelled medical images,
   clustering the class-labelled medical images into a number of clusters according to morphological, structural, and/or textural aspects,
   determining a color scheme from each medical image,
   generating a text for each medical image, wherein the text of each medical image comprises:
      the class-label of the medical image,
      the color scheme of the medical image, and
      a cluster index, wherein the cluster index indicates which cluster the medical image was assigned to,
   generating a first training dataset based on the medical images and the texts,
   training a text-to-image model on the first training dataset to generate synthetic medical images based on text prompts,
   generating a second training dataset using the trained machine learning model, and
   outputting the second training dataset.

In another aspect, the present disclosure provides a non-transitory computer readable storage medium having stored thereon software instructions that, when executed by a processor of a computer system, receiving a set of class-labelled medical images,
clustering the class-labelled medical images into a number of clusters according to morphological, structural, and/or textural aspects,
determining a color scheme from each medical image,
generating a text for each medical image, wherein the text of each medical image comprises:
   the class-label of the medical image,
   the color scheme of the medical image, and
   a cluster index, wherein the cluster index indicates which cluster the medical image was assigned to,
generating a first training dataset based on the medical images and the texts,
training a text-to-image model on the first training dataset to generate synthetic medical images based on text prompts,
generating a second training dataset using the trained machine learning model, and
outputting the second training dataset.

### BRIEF DESCRIPTION OF THE DRAWINGS

FIG. 1 (a) shows a number of histological images of breast tissue affected by breast cancer.

FIG. 1 (b) shows synthetic histological images generated using an existing text-to-image model.

FIG. 2 shows schematically the result of a cluster analysis based on embeddings of histological images.

FIG. 3 shows an example of how a color scheme is determined for each histological image.

FIG. 4 shows schematically the structure of a text generated for each histological image.

FIG. 5 shows schematically in the form of a flow chart an example of the method for training a machine learning model and generating synthetic medical images using the machine learning model.

FIG. 6 shows four examples of text prompts for generating synthetic histological images.

FIG. 7 shows a comparison of synthetic histological images and real histological images.

FIG. 8 illustrates a computer system according to some example implementations of the present disclosure in more detail.

FIG. 9 shows an embodiment of the computer-implemented method of the present disclosure in the form of a flow chart.

### DETAILED DESCRIPTION

Various example embodiments will be more particularly elucidated below without distinguishing between the aspects of the disclosure (method, computer system, computer-readable storage medium). On the contrary, the following elucidations are intended to apply analogously to all the aspects of the disclosure, irrespective of in which context (method, computer system, computer-readable storage medium) they occur.

If steps are stated in an order in the present description or in the claims, this does not necessarily mean that the disclosure is restricted to the stated order. On the contrary, it is conceivable that the steps can also be executed in a different order or else in parallel to one another, unless, for example, one step builds upon another step, this requiring that the building step be executed subsequently (this being, however, clear in the individual case). The stated orders may thus be exemplary embodiments of the present disclosure.

As used herein, the articles “a” and “an” are intended to include one or more items and may be used interchangeably with “one or more” and “at least one.” As used in the specification and the claims, the singular form of “a”, “an”, and “the” include plural referents, unless the context clearly dictates otherwise. Where only one item is intended, the term “one” or similar language is used. Also, as used herein, the terms “has”, “have”, “having”, or the like are intended to be open-ended terms. Further, the phrase “based on” is intended to mean “based at least partially on” unless explicitly stated otherwise. Further, the phrase “based on” may mean “in response to” and be indicative of a condition for automatically triggering a specified operation of an electronic device (e.g., a controller, a processor, a computing device, etc.) as appropriately referred to herein.

Some implementations of the present disclosure will be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art.

The present disclosure provides a means for generating synthetic images. The term “synthetic” as used herein may mean that the image is not the result of a physical measurement on a real object under examination, but that the image has been generated (calculated) by a generative machine learning model. For example, a synonym for the term “synthetic” may be the term “artificial”.

The term “image” as used herein may refer to a data structure that represents a spatial distribution of a physical signal. The spatial distribution may be of any dimension, for example 2D, 3D, 4D or any higher dimension. The spatial distribution may be of any shape, for example forming a grid and thereby defining pixels or voxels, the grid being possibly irregular or regular. The physical signal may be any signal, for example proton density, tissue echogenicity, tissue radiolucency, measurements related to the blood flow, information of rotating hydrogen nuclei in a magnetic field, color, level of gray, depth, surface or volume occupancy, such that the image may be a 2D or 3D RGB/grayscale/depth image, or a 3D surface/volume occupancy model. An image is usually composed of discrete image elements (e.g., pixels for 2D images, voxels for 3D images, doxels for 4D images).

In some embodiments, synthetic images are synthetic medical images.

A “medical image” is a representation of the human body or a part thereof or a visual representation of the body of an animal or a part thereof. For example, medical images may be visual, and maybe used, e.g., for diagnostic and/or treatment purposes. A widely used format for digital medical images is the DICOM format (DICOM: Digital Imaging and Communications in Medicine).

Techniques for generating medical images may include X-ray radiography, computerized tomography, fluoroscopy, magnetic resonance imaging, ultrasonography, endoscopy, elastography, tactile imaging, thermography, microscopy, positron emission tomography, optical coherence tomography, fundus photography, and others.

Examples of medical images include CT (computer tomography) scans, X-ray images, MRI (magnetic resonance imaging) scans, fluorescein angiography images, OCT (optical coherence tomography) scans, histological images, ultrasound images, fundus images and/or others.

In an embodiment, the medical image is a microscopic image, such as a whole slide histological image of a tissue of a human body. The histological image can be an image of a stained tissue sample. One or more dyes can be used to create the stained image. Usual dyes are hematoxylin and eosin.

In another embodiment, the medical image is a radiological image. “Radiology” is the branch of medicine concerned with the application of electromagnetic radiation and mechanical waves (including, for example, ultrasound diagnostics) for diagnostic, therapeutic and/or scientific purposes. In addition to X-rays, other ionizing radiation such as gamma rays or electrons are also used. Since a primary purpose is imaging, other imaging procedures such as sonography and magnetic resonance imaging (MRI) are also included in radiology, although no ionizing radiation is used in these procedures. Thus, the term “radiology” as used in the present disclosure includes, in particular, the following examination procedures: computed tomography, magnetic resonance imaging, sonography.

The radiological image can be, e.g., a 2D or 3D CT scan or MRI scan. The radiological image may be an image generated using a contrast agent or without a contrast agent. It may also be multiple images, one or more of which were generated using a contrast agent and one or more of which were generated without a contrast agent.

The synthetic medical images are generated using one or more machine learning models.

Such a “machine learning model”, as used herein, may be understood as a computer implemented data processing architecture. The machine learning model can receive input data and provide output data based on that input data and on parameters of the machine learning model (model parameters). The machine learning model can learn a relation between input data and output data through training. In training, parameters of the machine learning model may be adjusted in order to provide a desired output for a given input.

A process of training a machine learning model may involve providing a machine learning algorithm (that is the learning algorithm) with training data to learn from. The term “trained machine learning model” refers to the model artifact that is created by the training process. The training data includes a target. The learning algorithm finds patterns in the training data that map input data to the target, and it outputs a trained machine learning model that captures these patterns.

In an example training process, training data are inputted into the machine learning model and the machine learning model generates an output. The output is compared with the (known) target. Parameters of the machine learning model are modified in order to reduce the deviations between the output and the (known) target to a (defined) minimum.

In general, a loss function can be used for training, where the loss function can quantify the deviations between the output and the target. The loss function may be chosen in such a way that it rewards a wanted relation between output and target and/or penalizes an unwanted relation between an output and a target. Such a relation can be, e.g., a similarity, or a dissimilarity, or another relation.

A loss function can be used to calculate a loss for a given pair of output and target. The aim of the training process can be to modify (adjust) parameters of the machine learning model in order to reduce the loss to a (defined) minimum.

In the case of the present disclosure, a machine learning model is trained to generate synthetic medical images.

Training the machine learning model is done with training data. The training data includes a plurality of medical images. In some embodiments, the training data includes a multitude of medical images. The term “multitude” means more than ten, and in some embodiments more than a hundred. The medical images are real images, i.e., they are the result of a medical examination on a human or an animal.

The medical images are labeled. This means that information is present indicating what is in the image and/or who the image is of and/or what the image represents and/or how the image was created and/or other/further information about the image and/or the content of the image.

Usually, each medical image is assigned to one of at least two classes; a class label indicates to which class the medical image is assigned.

For example, there may be two classes, a first class representing medical images of an examination area of healthy examination subjects, and a second class representing medical images of an examination area of examination subjects suffering from a (specific) disease.

The “examination area” is a part of the examination subject, for example, an organ or a part of an organ.

For example, the “examination area” may be a liver, a kidney, a heart, a lung, a brain, a stomach, a bladder, a prostate gland, an intestine or part thereof, or any other part of the body of a human or an animal. In radiology, the examination area, also referred to as the field of view (FOV), particularly represents a volume that is imaged in radiological images. The examination area is typically defined by a radiologist, for example on a localizer. The examination area can also be determined automatically, for example on the basis of a selected protocol.

For example, each medical image from the multitude of medical images may be assigned to one of at least two classes, where the class indicates whether signs of a disease are present in the medical image and/or what disease is present and/or how severe the disease is.

For example, the class may indicate whether a lesion is present and/or what type of lesion it is and/or whether the lesion is benign or malignant.

The classes can indicate whether a tumor tissue shown in the medical image is due to a specific gene mutation (e.g., NTRK or BRAF or another mutation).

Based on the label information, a text is generated for each medical image. The text contains the respective label information, e.g., the class to which the medical image is assigned.

Based on the text, a text prompt is generated at a later time, which can be used to generate one or more specific synthetic images. In some cases, the class information often is insufficient to use a text prompt to generate artificial medical images that can be used to train machine learning models.

Therefore, the text is enriched with further information in a next step. This further information is generated automatically from the medical images. “Automatically” as used herein refers to without the intervention of a human being.

Such further information can be or comprise, for example, a cluster index. A cluster index can be the result of a cluster analysis. The multitude of medical images can be subjected to cluster analysis to divide the medical images into clusters. The classification of the clusters can be based on morphological, textural, structural, color and/or other/further characteristics of the content of the medical images.

Cluster analysis is performed based on embeddings representing the medical images rather than on the medical images themselves.

The term “embedding” refers to the process of representing data, typically high-dimensional data, in a lower-dimensional space. This is often used for transforming categorical variables or discrete entities into a continuous vector space, where each entity is represented by a set of learned parameters.

An “embedding” is a numerical representation of a (medical) image, usually in the form of a vector. In such an embedding, such features of a (medical) image can be summarized that make up the content of the (medical) image. Thus, the embedding can be a compressed representation of the (medical) image.

An embedding is also referred to as a feature vector. The term “vector” includes matrices, tensors and other arrangements of numbers.

In one embodiment, each embedding has the same defined (fixed) size (dimension), independent of the size of the medical image. This makes it easier to compare embeddings with each other; this facilitates a cluster analysis based on similarities of embeddings.

In another embodiment, the embeddings are translational invariant or translational equivariant. In a medical image, an object (such as a lesion) can appear at different locations in the image. However, in a cluster analysis, it should not matter where the object appears in the image (usually only the spatial relationship to other objects in the image is of interest).

Embeddings can be created in several ways.

Embeddings can be created with the help of an autoencoder, for example. An “autoencoder” is a machine learning model that is trained in an unsupervised training to compress input information and recreate it correctly with the compressed information. An autoencoder comprises an encoder, a decoder, and a bottleneck between the encoder and the decoder. The bottleneck is used for dimension reduction. The encoder is trained to extract features from input information and agglomerate them into a compressed representation with a smaller dimension than the input information; the decoder can be trained to reconstruct the input information from the compressed representation. Thus, the autoencoder learns to ignore noise in the input information. The compressed representation, e.g., of a medical image as input data is an embedding (a feature vector) of the medical image.

An autoencoder is often implemented as an artificial neural network that comprises a convolutional neural network (CNN) to extract features from medical images as input data. An example of such an autoencoder is the U-Net (see, e.g., Ronneberger, O., et al.: U-net: Convolutional networks for biomedical image segmentation, International Conference on Medical image computing and computer-assisted intervention, 234-241, Springer, 2015, DOI: 10.1007/978-3-319-24574-4_28).

A CNN is a class of deep neural networks, most commonly applied to analyzing visual imagery. A CNN comprises an input layer with input neurons, an output layer with at least one output neuron, as well as multiple hidden layers between the input layer and the output layer. The hidden layers of a CNN typically consist of convolutional layers, activation functions (e.g., ReLU (Rectified Linear Units) layers), pooling layers, fully connected layers and normalization layers.

The nodes in the CNN input layer are organized into a set of “filters” (feature detectors), and the output of each set of filters is propagated to nodes in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input image. The convolution kernel can be a multidimensional array of parameters, where the parameters are adapted by the training process for the neural network.

The objective of the convolution operation is to extract features (such as, e.g., edges from an input image). Conventionally, the first convolutional layer is responsible for capturing the low-level features such as edges, color, gradient orientation, etc. With added layers, the architecture adapts to the high-level features as well, giving a network exhibiting an understanding of images in the dataset. Similar to the convolutional layer, the pooling layer is responsible for reducing the spatial size of the feature maps. It is useful for extracting dominant features with some degree of rotational and positional invariance, thus maintaining the process of effectively training of the model. Adding a fully-connected layer is a way of learning non-linear combinations of the high-level features as represented by the output of the convolutional part.

A machine learning model configured as a classifier and trained to assign a medical image to a class can also be used to generate embeddings for medical images. The class information of the labels of the medical images can be used as target data. For example, such an image classifier may comprise a convolutional neural network (CNN) that performs feature extraction in a first step and generates an embedding based on a medical image. In a second step, a class is assigned to the embedding.

Numerous examples of image classifiers are published in the literature (see, e.g., Ramos Michel, A., et al.: Image Classification with Convolutional Neural Networks, (2021), DOI: 10.1007/978-3-030-70542-8_18).

The image classifier can be an image classifier pre-trained on publicly available data (such as images from the ImageNet (https://www.image-net.org/)). Similarly, an autoencoder can also be pre-trained using publicly available images. Such pre-training has the advantage that fewer medical images are needed for the final training of the model with medical images.

Instead of or in addition to an artificial neural network, a transformer-based model can also be used to generate embeddings, such as a vision transformer.

A vision transformer is a machine learning model commonly used for image classification. A vision transformer employs a transformer-like architecture over image patches: an image is divided into fixed-size patches, each of these patches is then linearly embedded, position embeddings are added, and the resulting sequence of vectors can be fed to a standard transformer encoder (see, e.g.: Dosovitskiy, A., et al.: An Image is Worth 16×16 Words: Transformers for Image Recognition at Scale, arXiv:2010.11929v2).

In some embodiments, the vision transformer has been pre-trained in a self-supervised pre-training on publicly available images. A method for self-supervised learning of vision transformers is for example “self-distillation with no labels” or DINO for short (see e.g.: Caron, M., et al.: Emerging Properties in Self-Supervised Vision Transformers, arXiv:2104.14294v2). In such a training, the vision transformer learns to semantically segment objects in images and create boundaries. This information is accessible in the self-attention modules of the transformer. The learned feature representations, i.e., the output vectors of the transformer (the embeddings), can be used to perform cluster analysis.

Once an embedding has been generated for each medical image of the multitude of medical images, the multitude of embeddings can be subjected to cluster analysis.

“Cluster analysis” or “clustering” is the task of grouping a set of objects (e.g., embeddings) in such a way that objects in the same group (called a cluster) are more similar (in some sense) to each other than to those in other groups (clusters).

There are a variety of clustering methods. As an example, the k-means clustering may be mentioned without limiting the disclosure to this method.

“k-means clustering” is a method of vector quantization that is also used for cluster analysis. It involves forming a previously known number of k groups from a set of similar objects. The algorithm is one of the most commonly used techniques for grouping objects, as it quickly finds the centers of clusters. Thereby, the algorithm prefers groups with low variance and similar size. The method aims to partition n objects into k clusters in which each object belongs to the cluster with the nearest mean (cluster centers or cluster centroid), serving as a prototype of the cluster. Details about k-means clustering and other cluster analyses can be found in textbooks and scientific articles (see, e.g.: Landau, S., et al.: Cluster Analysis: Overview, International Encyclopedia of Education, 2010, 72-83, 10.1016/B978-0-08-044894-7.01315-4).

If the clustering method is one in which the number of clusters is predetermined (as in k-means clustering), a user of the computer system according to the present disclosure can specify (enter into the computer system and/or select) a respective number (k). The number can be specified based on the medical images available. The number may be based on differences in the visual appearance of the medical images. For example, the number of clusters can be based on morphological, textural, structural, color and/or other/further aspects. The term “aspects” can be equated with the term “features”.

“Morphological aspects” of an image refer to the structure, shape, and/or form of objects within the image.

“Structural aspects” of an image encompass the arrangement, organization, and relationships between objects and elements within the image.

“Textural aspects” of an image pertain to the visual patterns, variations, and surface characteristics present within the image.

For example, if the medical images are histological images in which the cell number or cell density varies, a number of different cell numbers or cell densities that occur can be specified. For example, a number of three clusters may be specified, a first cluster for histology images with a low number of cells or a low cell density, a second cluster for histology images with a medium number of cells or a medium cell density, and a third cluster for histology images with a high number of cells or a high cell density.

Histological images may be stained with different dyes. The number of clusters can be specified according to the number of dyes present or the number of dye combinations present.

If the medical images are radiological images taken at different time periods (phases) before and/or after the application of a contrast agent, the number of clusters can be specified as the number of time periods (phases) depicted in the radiological images. For example, a magnetic resonance imaging study of the liver of a mammal using a hepatobiliary contrast agent involves a (1) native phase, (2) an arterial phase, (3) a portal-vein phase, (4) a transitional phase, and (5) a hepatobiliary phase. The number of clusters for such medical images may be, for example, five (5).

In magnetic resonance imaging (MRI) examinations, different measurement protocols can be used to highlight different aspects in the radiological images. T1-weighted MRI enhances the signal of the fatty tissue and suppresses the signal of the water. T2-weighted MRI enhances the signal of the water. The number of clusters can be specified according to the number of different measurement protocols available.

After cluster analysis, each cluster can be represented by an index, for example, a number or an alphanumeric string or a word or a number of words. For each medical image, the cluster index of each cluster to which the embedding of the medical image was assigned in the cluster analysis can be included in the text of the medical image.

It is possible that different cluster analyses are performed according to different aspects and different cluster indices are determined for each medical image.

Another way to enrich the text of each medical image with information, especially in the case of colored medical images (such as histological images), is to assign a color scheme to each image and include the corresponding color scheme as additional information in the text of the medical image.

A “color scheme” refers to a predefined set of colors that are used to display information or convey data visually. However, the term “color scheme” is not limited to colored images; the methods described herein can also be applied to grayscale images.

The particular color scheme can be determined for histological images based on the dye(s) and/or the amount(s) of dye(s) used and/or how the histological images were stained.

Unfortunately, this information is often not available. Therefore, the color scheme can also be determined on the basis of the medical image itself. Depending on the color coding of the medical images, at least one color value is assigned to each image element (e.g. pixel or voxel). In the case of color coding according to the RGB color model or the HSV color model, three color values are assigned to each image element; in the case of the CMYK color model, there are four. Based on the color values of the image elements, a color scheme can be defined for each medical image. There are a number of different options for this.

For example, a mean (e.g., arithmetically averaged) color value can be determined for each medical image, or multiple mean color values can be determined.

For example, in case of an RGB color model, an average R value and/or an average G value and/or an average B value can be calculated (averaged over all image elements of the respective medical image). In case of an HSV color model, an average H value and/or an average S value and/or an average V value can be calculated. If more than one average color value is calculated, the multiple average color values can be combined into one vector. The average color value or vector represents the color scheme of the respective medical image in a numerical form. The color scheme in numerical form can be included in the text of the medical image. It is also possible to assign an alphanumeric code or name to the color scheme and include the alphanumeric code or name in the text.

It is also possible to perform a cluster analysis based on (average) color values to divide the medical images into a number of color scheme groups. Each color scheme group (cluster) can then be represented by a cluster index. The cluster index can be an arbitrary number. However, the cluster index can also be a name for the corresponding color scheme. For example, colors used to display web pages have names (see, e.g., https://www.w3.org/TR/2011/REC-css3-color-20110607/). For each color scheme, the web color that is closest to the color scheme can be determined, and the color scheme of the respective medical image can be represented by the determined web color.

All information determined about the medical images is included in the medical image texts. Such a text can be, for example, a sequence of words (text string).

The medical images along with the respective texts (herein referred to as first training dataset) are used to train a machine learning model. The machine learning model is trained to generate a medical image based on a text prompt that realizes the information contained in the text prompt. In other words, the machine learning model is a text-to-image model that is configured and trained to turn text input (text prompts) into images.

For example, the machine learning model can be a diffusion model. Diffusion models work by destroying training data through the successive addition of noise, and then learning to recover the data by reversing this noising process. After training, the trained diffusion model can be used to generate data by passing randomly sampled noise through the learned denoising process (see, e.g., Zhang, C., et al.: Text-to-image Diffusion Models in Generative AI: A Survey, arXiv:2303.07909v2).

In the case of medical images, gradually more noise can be added to each medical image until the medical image is completely destroyed (consists only of noise). The noise can be, for example, Gaussian noise. The stepwise addition of noise to a medical image can be treated as a Markov chain, i.e., the state of an image in the chain is determined by the state of the image preceding it in the chain.

The goal of training a diffusion model is to learn the reverse process, i.e., the stepwise denoising of a medical image. The diffusion model is trained by finding the reverse Markov transitions that maximize the likelihood of the training data. Once such a diffusion model has been trained, it can generate an image from noise.

To control the process of image generation, further information can be included in the training and/or inference, which can be used as conditions during image generation. In the case of the medical images, the information in the texts of the medical images can be used as conditions.

Training a model for conditional image generation is described in the literature (see, e.g., Batzolis, G., et al.: Conditional Image Generation with Score-Based Diffusion Models, arXiv:2111.13606v1; Zhang, L., et al.: Adding Conditional Control to Text-to-Image Diffusion Models, arXiv:2302.05543v1).

Once the text-to-image model has been trained based on the first training dataset, it can be used to generate synthetic medical images.

To generate a synthetic image an image containing randomly sampled noise together with a text prompt is inputted into the trained text-to-image model. The trained text-to-image model then outputs a synthetic image.

In order to create a synthetic image dataset that can be used for training purposes, a set of text prompts is created that describe what the synthetic medical images should represent and/or how they should represent it. Each text prompt contains a class label, a cluster index, a color scheme, as well as possibly other information that were used in training the text-to-image model.

The text prompts can be chosen to cover as wide a range of different cases as possible so that the synthetic medical images also represent as wide a range as possible. It is possible to create text prompts for every possible feature combination to produce synthetic medical images that cover every combination. However, it is possible that the number of all possible combinations is too large (combinatorial explosion). It is also possible that the combinations do not occur in reality with the same probability. Statistical methods can be used to create text prompts that are representative of the feature space.

The set of text prompts can then be used to create a dataset of synthetic medical images. This dataset is also referred to as the second training dataset in this description. This second training dataset can be used to train another machine learning model. The second training dataset can also be combined with the first training dataset, and the combined dataset can then be used to train another machine learning model. In other words, the other machine learning model can be trained using real (first training dataset) and synthetic medical images (second training dataset).

For example, the other machine learning model may be a model for classifying medical images, i.e., the model may be configured and trained to assign a medical image to a class. The medical image may be used as input data and the class label may be used as target data. Further possibilities are conceivable.

Thus, in this disclosure, at least two machine learning models are discussed, a first machine learning model and a second machine learning model. The first model is an image generating model, for example a text-image model. It is trained to generate artificial training images for training the second machine learning model.

The second machine learning model is an image-utilizing model. It is trained to perform a task based on at least one image using the generated synthetic training images (and possibly other images and/or data). The task to be performed by the second model can be a segmentation, classification, regression and/or any other task.

Examples of image-utilizing machine learning models and applications for their use are described below. However, the present disclosure is not limited to these examples.

The second machine learning model can be trained and the trained second machine learning model can be used to detect, identify, and/or characterize tumor types and/or gene mutations in tissues.

The second machine learning model can be trained and the trained second machine learning model can be used to recognize a specific gene mutation and/or a specific tumor type, or to recognize multiple gene mutations and/or multiple tumor types.

The second machine learning model can be trained and the trained second machine learning model can be used to characterize the type or types of cancer a patient or subject has.

The second machine learning model can be trained and the trained second machine learning model can be used to select one or more effective therapies for the patient.

The second machine learning model can be trained and the trained second machine learning model can be used to determine how a patient is responding over time to a treatment and, if necessary, to select a new therapy or therapies for the patient as necessary. Correctly characterizing the type or types of cancer a patient has and, potentially, selecting one or more effective therapies for the patient can be crucial for the survival and overall wellbeing of that patient.

The second machine learning model can be trained and the trained second machine learning model can be used to determine whether a patient should be included or excluded from participating in a clinical trial.

The second machine learning model can be trained and the trained second machine learning model can be used to classify images of tumor tissue in one or more of the following classes: inflamed, non-inflamed, vascularized, non-vascularized, fibroblast-enriched, non-fibroblast-enriched (such classes are defined, e.g., in EP3639169A1).

The second machine learning model can be trained and the trained second machine learning model can be used to identify differentially expressed genes in a sample from a subject (e.g., a patient) having a cancer (e.g., a tumor).

The second machine learning model can be trained and the trained second machine learning model can be used to identify genes that are mutated in a sample from a subject having a cancer (e.g., a tumor).

The second machine learning model can be trained and the trained second machine learning model can be used to identify a cancer (e.g., a tumor) as a specific subtype of cancer selected.

Such uses may be useful for clinical purposes including, for example, selecting a treatment, monitoring cancer progression, assessing the efficacy of a treatment against a cancer, evaluating suitability of a patient for participating in a clinical trial, or determining a course of treatment for a subject (e.g., a patient).

The trained second machine learning model may also be used for non-clinical purposes including (as a non-limiting example) research purposes such as, e.g., studying the mechanism of cancer development and/or biological pathways and/or biological processes involved in cancer, and developing new therapies for cancer based on such studies.

The first and/or the second machine learning model of the present disclosure are trained based on images and the second machine learning model may generate predictions based on images. The images may show the tissue of one or more subjects. The images may be created from tissue samples of a subject.

The tissue sample may be any sample from a subject known or suspected of having cancerous cells or pre-cancerous cells.

The tissue sample may be from any source in the subject's body including, but not limited to, skin (including portions of the epidermis, dermis, and/or hypodermis), bone, bone marrow, brain, thymus, spleen, small intestine, appendix, colon, rectum, liver, gall bladder, pancreas, kidney, lung, ureter, bladder, urethra, uterus, ovary, cervix, scrotum, penis, prostate.

The tissue sample may be a piece of tissue, or some or all of an organ.

The tissue sample may be a cancerous tissue or organ or a tissue or organ suspected of having one or more cancerous cells.

The tissue sample may be from a healthy (e.g. non-cancerous) tissue or organ.

The tissue sample may include both healthy and cancerous cells and/or tissue.

In certain embodiments, one sample has been taken from a subject for analysis. In some embodiments, more than one (e.g., 2, 3, 4, 5, 6, 7, 8, 9, 10, 11, 12, 13, 14, 15, 16, 17, 18, 19, 20, or more) samples may have been taken from a subject for analysis.

In some embodiments, one sample from a subject will be analyzed. In certain embodiments, more than one (e.g., 2, 3, 4, 5, 6, 7, 8, 9, 10, 11, 12, 13, 14, 15, 16, 17, 18, 19, 20, or more) samples may be analyzed. If more than one sample from a subject is analyzed, the samples may have been procured at the same time (e.g., more than one sample may be taken in the same procedure), or the samples may have been taken at different times (e.g., during a different procedure including a procedure 1, 2, 3, 4, 5, 6, 7, 8, 9, 10 days; 1, 2, 3, 4, 5, 6, 7, 8, 9, 10 weeks; 1, 2, 3, 4, 5, 6, 7, 8, 9, 10 months, 1, 2, 3, 4, 5, 6, 7, 8, 9, 10 years, or 1, 2, 3, 4, 5, 6, 7, 8, 9, 10 decades after a first procedure). A second or subsequent sample may be taken or obtained from the same region (e.g., from the same tumor or area of tissue) or a different region (including, e.g. a different tumor). A second or subsequent sample may be taken or obtained from the subject after one or more treatments and may be taken from the same region or a different region. As a non-limiting example, the second or subsequent sample may be useful in determining whether the cancer in each sample has different characteristics (e.g., in the case of samples taken from two physically separate tumors in a patient) or whether the cancer has responded to one or more treatments (e.g., in the case of two or more samples from the same tumor prior to and subsequent to a treatment).

Any of the samples described herein may have been obtained from the subject using any known technique. In some embodiments, the sample may have been obtained from a surgical procedure (e.g., laparoscopic surgery, microscopically controlled surgery, or endoscopy), bone marrow biopsy, punch biopsy, endoscopic biopsy, or needle biopsy (e.g., a fine-needle aspiration, core needle biopsy, vacuum-assisted biopsy, or image-guided biopsy).

Detection, identification, and/or characterization of tumor types may be applied to any cancer and any tumor. Exemplary cancers include, but are not limited to, adrenocortical carcinoma, bladder urothelial carcinoma, breast invasive carcinoma, cervical squamous cell carcinoma, endocervical adenocarcinoma, colon adenocarcinoma, esophageal carcinoma, kidney renal clear cell carcinoma, kidney renal papillary cell carcinoma, liver hepatocellular carcinoma, lung adenocarcinoma, lung squamous cell carcinoma, ovarian serous cystadenocarcinoma, pancreatic adenocarcinoma, prostate adenocarcinoma, rectal adenocarcinoma, skin cutaneous melanoma, stomach adenocarcinoma, thyroid carcinoma, uterine corpus endometrial carcinoma, and cholangiocarcinoma.

The second machine learning model can be trained and the trained machine learning model can be used to detect, identify and/or characterize gene mutations in tissue samples.

Examples of genes related to proliferation of cancer or response rates of molecular target drugs include HER2, TOP2A, HER3, EGFR, P53, and MET. Examples of tyrosine kinase related genes include ALK, FLT3, AXL, FLT4 (VEGFR3, DDR1, FMS(CSF1R), DDR2, EGFR(ERBB1), HER4(ERBB4), EML4-ALK, IGF1R, EPHA1, INSR, EPHA2, IRR(INSRR), EPHA3, KIT, EPHA4, LTK, EPHA5, MER(MERTK), EPHA6, MET, EPHA7, MUSK, EPHA8, NPM1-ALK, EPHB1, PDGFRα(PDGFRA), EPHB2, PDGFRβ(PDGFRB)EPHB3, RET, EPHB4, RON(MST1R), FGFR1, ROS(ROS1), FGFR2, TIE2(TEK), FGFR3, TRKA(NTRK1), FGFR4, TRKB(NTRK2), FLT1(VEGFR1), and TRKC(NTRK3). Examples of breast cancer related genes include ATM, BRCA1, BRCA2, BRCA3, CCND1, E-Cadherin, ERBB2, ETV6, FGFR1, HRAS, KRAS, NRAS, NTRK3, p53, and PTEN. Examples of genes related to carcinoid tumors include BCL2, BRD4, CCND1, CDKN1A, CDKN2A, CTNNB1, HES1, MAP2, MEN1, NF1, NOTCH1, NUT, RAF, SDHD, and VEGFA. Examples of colorectal cancer related genes include APC, MSH6, AXIN2, MYH, BMPR1A, p53, DCC, PMS2, KRAS2 (or Ki-ras), PTEN, MLH1, SMAD4, MSH2, STK11, and MSH6. Examples of lung cancer related genes include ALK, PTEN, CCND1, RASSF1A, CDKN2A, RB1, EGFR, RET, EML4, ROS1, KRAS2, TP53, and MYC. Examples of liver cancer related genes include Axin1, MALAT1, b-catenin, p16 INK4A, c-ERBB-2, p53, CTNNB1, RB1, Cyclin D1, SMAD2, EGFR, SMAD4, IGFR2, TCF1, and KRAS. Examples of kidney cancer related genes include Alpha, PRCC, ASPSCR1, PSF, CLTC, TFE3, p54nrb/NONO, and TFEB. Examples of thyroid cancer related genes include AKAP10, NTRK1, AKAP9, RET, BRAF, TFG, ELE1, TPM3, H4/D10S170, and TPR. Examples of ovarian cancer related genes include AKT2, MDM2, BCL2, MYC, BRCA1, NCOA4, CDKN2A, p53, ERBB2, PIK3CA, GATA4, RB, HRAS, RET, KRAS, and RNASET2. Examples of prostate cancer related genes include AR, KLK3, BRCA2, MYC, CDKN1B, NKX3.1, EZH2, p53, GSTP1, and PTEN. Examples of bone tumor related genes include CDH11, COL12A1, CNBP, OMD, COL1A1, THRAP3, COL4A5, and USP6.

In one embodiment, the second machine learning model is trained and used for classification of tissue types on the basis of whole slide images. In another embodiment, the machine learning model is trained and used for identification of gene mutations, such as BRAF mutations and/or NTRK fusions, as described in WO 2020/229152 A1 and/or Hoehne, J., et al.: Detecting genetic alterations in BRAF and NTRK as oncogenic drivers in digital pathology images: towards model generalization within and across multiple thyroid cohorts, Proceedings of Machine Learning Research 156, 2021, pages 1-12, the contents of which are incorporated by reference in their entirety into this specification.

For example, the second machine learning model can be trained to detect signs of the presence of oncogenic drivers in patient tissue images stained with hematoxylin and eosin.

Penault-Llorca, F., et al. describe a testing algorithm for identification of patients with TRK fusion cancer (see J. Clin. Pathol., 2019, 72, 460-467). The algorithm comprises immunohistochemistry (IHC) studies, fluorescence in situ hybridization (FISH) and next-generation sequencing.

Immunohistochemistry provides a routine method to detect protein expression of NTRK genes. However, performing immunohistochemistry requires additional tissue section(s) and time to proceed and interprete (following hematoxylin and eosin initial staining based on which tumor diagnosis is performed), skills and the correlation between protein expression and gene fusion status is not trivial. Interpretation of IHC results requires the skills of a trained and certified medical professional pathologist.

Similar practical challenges hold true for other molecular assays such as FISH.

Next-generation sequencing provides a precise method to detect NTRK gene fusions. However, performing gene analyses for each patient is expensive, tissue consuming (not always feasible when available tissue specimen is minimal, as in diagnostic biopsies), not universally available in various geographic locations or diagnostic laboratories/healthcare institutions and, due to the low incidence of NTRK oncogenic fusions, inefficient.

There is therefore a need for a comparatively rapid and inexpensive method to detect signs of the presence of specific tumors.

It is proposed to train the second machine learning model as described in this disclosure to assign histological images of tissues from patients to one of at least two classes, where one class comprises images showing tissue in which a specific gene mutation is present, such as NTRK or BRAF. It is proposed to use the trained machine learning model as a preliminary test. Patients in whom the specific mutation can be detected are then subjected to a standard examination such as IHC, FISH and/or next-generation sequencing to verify the finding.

Additional studies may also be considered, such as other forms of medical imaging (CT scans, MRI, etc.) that can be co-assessed using AI to generate multimodal biomarkers/characteristics for diagnostic purposes.

The second machine learning model of the present disclosure can, e.g., be used to
a) detect NTRK fusion events in one or more indications,
b) detect NTRK fusion events in other indications than in those being trained on (i.e., an algorithm trained on thyroid data sets is useful in lung cancer data sets),
c) detect NTRK fusion events involving other TRK family members (i.e., an algorithm trained on NTRK1, NTRK3 fusions is useful to predict also NTRK2 fusions),
d) detect NTRK fusion events involving other fusion partners (i.e., an algorithm trained on LMNA-fusion data sets is useful also in TPM3-fusion data sets),
e) discover novel fusion partners (i.e., an algorithm trained on known fusion events might predict a fusion in a new data set which is then confirmed via molecular assay to involve a not yet described fusion partner of a NTRK family member),
f) catalyze the diagnostic workflow and clinical management of patients offering a rapid, tissue-sparing, low-cost method to indicate the presence of NTRK-fusions (and ultimately others) and identifying patients that merit further downstream molecular profiling so as to provide precision medicines targeting specific molecular aberrations (e.g., NTRK-fusion inhibitors),
g) identify specific genetic aberrations based on histological specimen can additionally be used to confirm/exclude or re-label certain tumor diagnosis, in cases the presence or absence of this/these alterations(s) is pathognomonic of specific tumors.

Identification of specific genetic aberrations based on histological specimen can additionally be used to confirm/exclude or re-label certain tumor diagnosis, in cases the presence or absence of this/these alterations(s) is pathognomonic of specific tumors.

Histological images used for training and prediction of the first and/or second machine learning model can be obtained from patients by biopsy or surgical resection specimens.

In one embodiment, a histological image is a microscopic image of tumor tissue of a human patient. The magnification factor is preferably in the range of 10 to 60, more preferably in the range of 20 to 40, whereas a magnification factor of, e.g., “20” means that a distance of 0.05 mm in the tumor tissue corresponds to a distance of 1 mm in the image (0.05 mm×20=1 mm).

In another embodiment, the histological image is a whole-slide image.

In yet another embodiment, the histological image is an image of a stained tumor tissue sample. One or more dyes can be used to create the stained images. In some embodiments, the one or more dyes are hematoxylin and/or eosin.

Methods for creating histological images, in particular stained whole-slide microscopy images, are extensively described in scientific literature and textbooks (see e.g., Suvarna, S. K., et al.: Bancroft's Theory and Practice of Histological Techniques, 8^{th} Ed., Elsevier 2019, ISBN 978-0-7020-6864-5; Frangi, A. F., et al.: Medical Image Computing and Computer Assisted Intervention—MICCAI 2018, 21^{st} International Conference Granada, Spain, 2018 Proceedings, Part II, ISBN 978-030-00933-5; Junqueira, L. C., et al.: Histologie, Springer 2001, ISBN: 978-354-041858-0; Coudray, N., et al.: Classification and mutation prediction from non-small cell lung cancer histopathology images using deep learning, Nature Medicine, Vol. 24, 2018, pages 1559-1567).

The second machine learning model can also be configured to generate a probability value, the probability value indicating the probability of a patient suffering from cancer, e.g., caused by an NTRK oncogenic fusion. The probability value can be outputted to a user and/or stored in a database. The probability value can be a real number in the range from 0 to 1, whereas a probability value of 0 usually means that it is impossible that the cancer is caused by an NTRK oncogenic fusion, and a probability value of 1 usually means that there is no doubt that the cancer is caused by an NTRK oncogenic fusion. The probability value can also be expressed by a percentage.

In a certain embodiment of the present disclosure, the probability value is compared with a predefined threshold value. In the event the probability value is lower than the threshold value, the probability that the patient suffers from cancer caused by an NTRK oncogenic fusion is low; treating the patient with a Trk inhibitor is not indicated; further investigations are required in order to determine the cause of cancer. In the event the probability value equals the threshold value or is greater than the threshold value, it is reasonable to assume that the cancer is caused by an NTRK oncogenic fusion; the treatment of the patient with a Trk inhibitor can be indicated; further investigations to verify the assumption can be initiated (e.g., performing a genetic analysis of the tumor tissue).

The threshold value can be a value between 0.5 and 0.99999999999, e.g., 0.8 (80%) or 0.81 (81%) or 0.82 (82%) or 0.83 (83%) or 0.84 (84%) or 0.85 (85%) or 0.86 (86%) or 0.87 (87%) or 0.88 (88%) or 0.89 (89%) or 0.9 (90%) or 0.91 (91%) or 0.92 (92%) or 0.93 (93%) or 0.94 (94%) or 0.95 (95%) or 0.96 (96%) or 0.97 (97%) or 0.98 (98%) or 0.99 (99%) or any other value (percentage). The threshold value can be determined by a medical expert.

Besides a histological image, additional patient data can also be included in the classification. Additional patient data can be, e.g., anatomic or physiology data of the patient, such as information about patient's height and weight, gender, age, vital parameters (such as blood pressure, breathing frequency and heart rate), tumor grades, ICD-9 classification, oxygenation of tumor, degree of metastasis of tumor, blood count value tumor indicator value like PA value, information about the tissue the histological image is created from (e.g. tissue type, organ), further symptoms, medical history etc. Also, the pathology report of the histological images can be used for classification, using text mining approaches. Also, a next generation sequencing raw data set which does not cover the TRK genes' sequences can be used for classification.

The disclosure is explained in more detail below with reference to examples and drawings, without wishing to limit the disclosure to the examples or the features and combinations of features shown in the drawings.

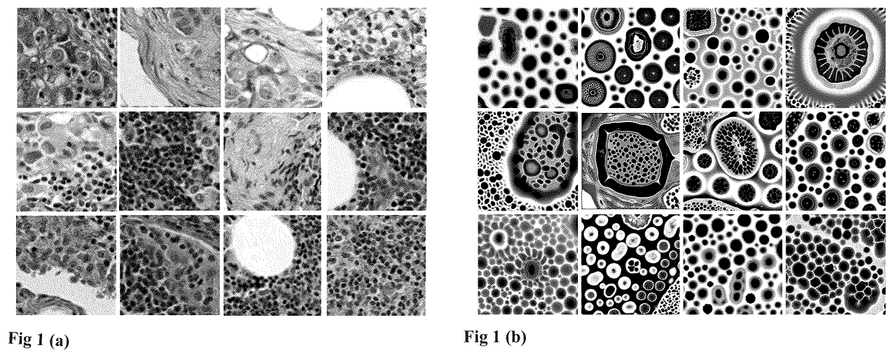

FIG. 1 (a) shows a number of histological images of breast tissue affected by breast cancer. Such histological images can be labeled, with the label indicating, for example, that the particular imageshows breast cancer cells. Using such labeled images, a text-to-image model can be trained to generate synthetic histology images.

FIG. 1 (b) shows synthetic histological images generated using an existing text-to-image model (such as Stable Diffusion, https://github.com/CompVis/stable-diffusion), where the text contained only the labeling information. In the example shown in FIG. 1 (b) a text prompt such as “a histological image showing breast cancer cells” was used to generate the synthetic images. The synthetic histological images do not reflect reality. Such synthetic histological images are not suitable as training data for training machine learning models.

To create synthetic histological images or other synthetic medical images that reflect reality, the text-to-image model needs to be (re-)trained on histological images, and texts describing the images need to be enriched with additional information. This additional information is preferably generated based on the histological images themselves, so that no further information about the images or the content of the images or the generation of the images needs to be available.

This additional information may include, for example, a cluster index representing morphological, textural, structural and/or color aspects of the histological images.

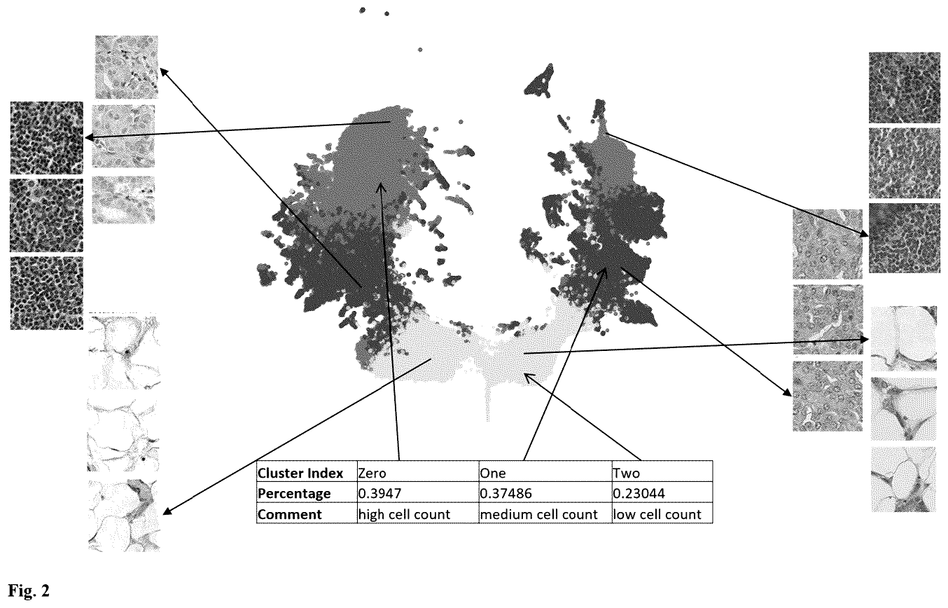

FIG. 2 shows schematically the result of a cluster analysis based on embeddings of histological images. A k-means clustering with k=3 was performed. The embeddings were created with a DINO vision transformer.

FIG. 2 shows the three clusters in a plot generated with UMAP (see, e.g., https://umap-learn.readthedocs.io/).

Each dot in the plot corresponds to a histological image; the shade of gray of a dot indicates the cluster to which the histological image has been assigned.

To the right and left of the plot are examples of histological images, and it is indicated which dot in the plot represents each example image.

It can be seen from the example images that clustering was based on morphological features of the images; the clusters obviously differ in cell density/cell number.

The table in FIG. 2 shows cluster indices in row 1, the percentages of images assigned to each cluster in row 2, and the criterion by which the clustering was obviously done in row 3 (“Comment”).

Unfortunately, the example images shown in FIG. 2 are grayscale images in this patent specification. If they were shown as color images, one would recognize that the images on the left side differ in color from the images on the right side, even though they are assigned to the same cluster. The color of the histological images is thus obviously another feature after which histological images can be distinguished. Color is another feature that can be included in a text describing an image.

So, as another information with which the texts of histological information can be enriched in a next step is a color scheme.

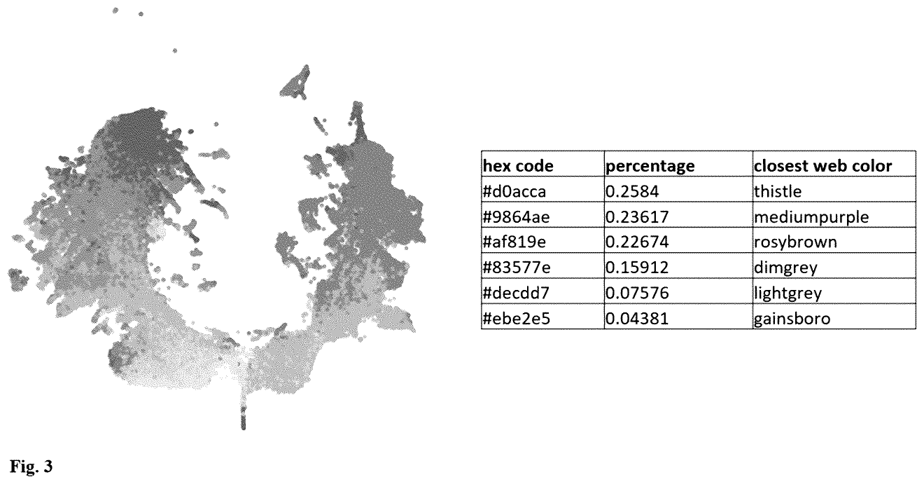

FIG. 3 shows an example of how a color scheme is determined for each histological image.

Color in the histological images of the present example is encoded according to the HSV color model. The average H-value and the average V-value were calculated for each image. A cluster analysis was then performed based on the averaged values. More precisely, a k-means clustering with k=6 was performed.

FIG. 3 shows the result of the cluster analysis in a plot generated with UMAP (see, e.g., https://umap-learn.readthedocs.io/).

An average color was determined for each cluster. The first column of the table in FIG. 3 shows the hex code of the average color for each cluster. The second column indicates the percentage of images that have the corresponding average color. The third column gives the name of the web color closest to the hex code. The name of the web color was used as the color scheme and included in the text describing each image.

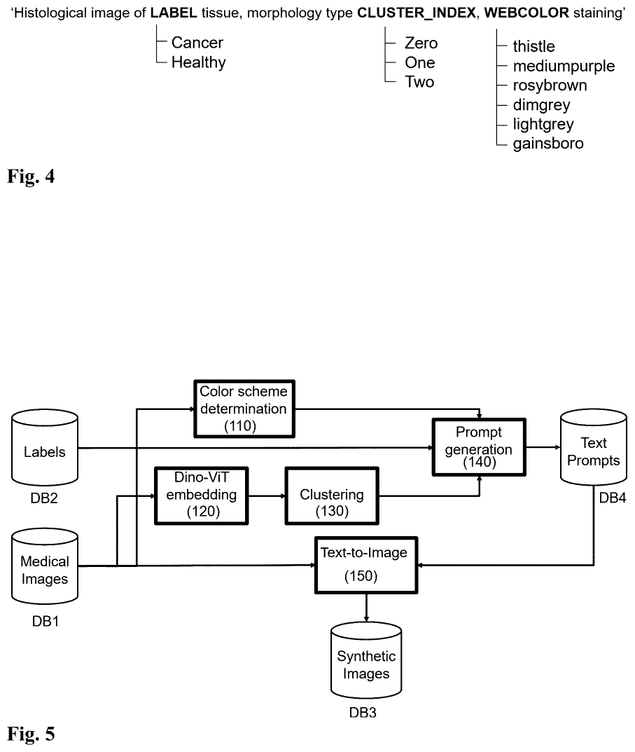

FIG. 4 shows schematically the structure of the text generated for each histological image. The LABEL, CLUSTER_INDEX and WEBCOLOR terms are variable terms.

The term LABEL specifies the respective class label. In this example, there are two classes; the “Cancer” class and the “Healthy” class. The class thus indicates whether the tissue shown in the histological image is healthy tissue or cancerous tissue.

The term CLUSTER_INDEX indicates to which cluster the respective histological image (or embedding of the histological image) has been assigned. The term CLUSTER_INDEX can assume the values “Zero”, “One” and “Two”.

Finally, the term WEBCOLOR indicates the color scheme of each histological image in terms of the closest web color. The term CLUSTER_INDEX can assume the values “rosybrown”, “lightgrey”, “gainsboro”, “dimgrey”, “thistle”, and “mediumpurple”.

For each histological image, a text as shown in FIG. 4 can be generated. The texts together with the histological images form a first training dataset that can be used to train a text-to-image model.

FIG. 5 shows schematically in the form of a flow chart an example of the method for training a machine learning model and generating synthetic medical images using the machine learning model.

In a first step (110), real medical images stored in a data memory (DB1) are analyzed to determine a color scheme for each medical image. In a further step (120), an embedding representing the respective medical image is generated for each medical image using a self-learning vision transformer (DINO-ViT). The embeddings of all medical images are subjected to a cluster analysis (Clustering) in a further step (130) and a cluster index is assigned to each medical image (not explicitly shown in FIG. 5). For each medical image, a text is generated in a next step (140) (Prompt generation). The determined color scheme, the cluster index and information from a label are included in the text. The label can indicate what is represented in the respective medical image, for example, whether the medical image is a representation of an examination area of a healthy examination object or whether the medical image is a representation of an examination area of an examination object that suffers from a certain disease. In the present example, the label is stored in a data store (DB2). The label may also be stored in the same data store (DB1) as the medical images. The texts can be stored in a database (DB4). The texts together with the medical images form a first training dataset, which is used in a further step (150) to train a text-to-image model to generate synthetic medical images. Once the text-to-image model is trained, it can be used to generate synthetic medical images. To do this, text prompts indicating what the synthetic medical images should represent and/or how the synthetic medical images should represent something are input to the text-to-image model. Such text prompt can be received from a database (DB4) or inputted by a user. For each text prompt inputted, the text-to-image model generates a synthetic medical image based on a randomly sampled noise image. The synthetic medical images can be stored in a data store (DB3).

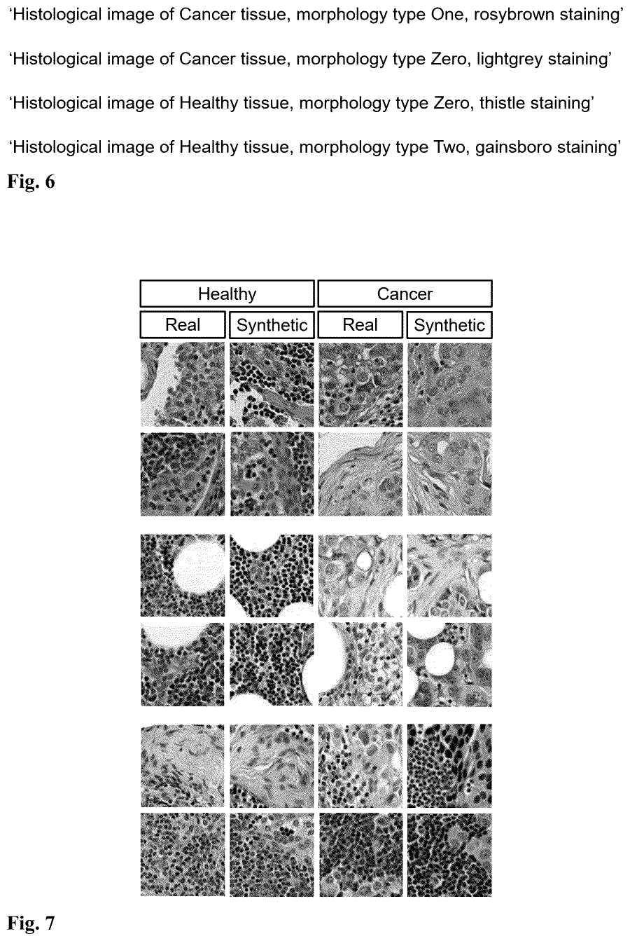

FIG. 6 shows four examples of text prompts for generating synthetic histological images.

FIG. 7 shows a comparison of synthetic histological images and real histological images. Without the information in FIG. 7 as to which of the histological images are real and which are synthetic, it is not possible to distinguish real from synthetic images. This is true for images showing healthy tissue as well as for images showing cancerous tissue. This shows the high quality of the synthetic medical images generated in accordance with the methods described herein. Such synthetic medical images can be used to train a machine learning model.

The operations in accordance with the teachings herein may be performed by at least one computer specially constructed for the desired purposes or general purpose computer specially configured for the desired purpose by at least one computer program stored in a typically non-transitory computer readable storage medium.

The term “non-transitory” is used herein to exclude transitory, propagating signals or waves, but to otherwise include any volatile or non-volatile computer memory technology suitable to the application.

The term “computer” should be broadly construed to cover any kind of electronic device with data processing capabilities, including, by way of non-limiting example, personal computers, servers, embedded cores, computing system, communication devices, processors (e.g., digital signal processor (DSP)), microcontrollers, field programmable gate array (FPGA), application specific integrated circuit (ASIC), etc.) and other electronic computing devices.

The term “process” as used above is intended to include any type of computation or manipulation or transformation of data represented as physical, e.g., electronic, phenomena which may occur or reside e.g., within registers and/or memories of at least one computer or processor. The term processor includes a single processing unit or a plurality of distributed or remote such units.

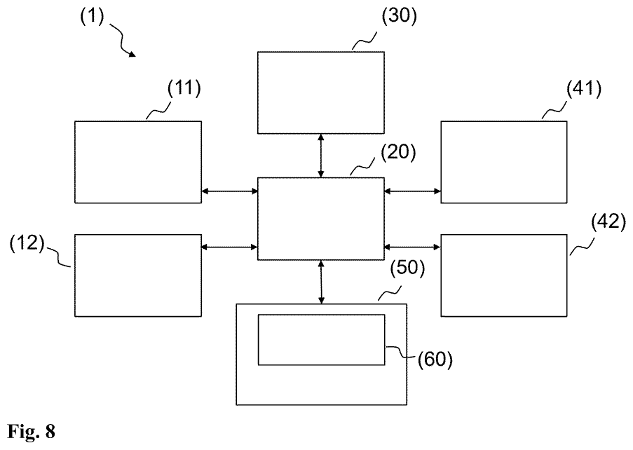

FIG. 8 illustrates a computer system (1) according to some example implementations of the present disclosure in more detail. The computer may include one or more of each of a number of components such as, for example, processing unit (20) connected to a memory (50) (e.g., storage device).

The processing unit (20) may be composed of one or more processors alone or in combination with one or more memories. The processing unit is generally any piece of computer hardware that is capable of processing information such as, for example, data, computer programs and/or other suitable electronic information. The processing unit is composed of a collection of electronic circuits some of which may be packaged as an integrated circuit or multiple interconnected integrated circuits (an integrated circuit at times more commonly referred to as a “chip”). The processing unit may be configured to execute computer programs, which may be stored onboard the processing unit or otherwise stored in the memory (50) of the same or another computer.

The processing unit (20) may be a number of processors, a multi-core processor or some other type of processor, depending on the particular implementation. Further, the processing unit may be implemented using a number of heterogeneous processor systems in which a main processor is present with one or more secondary processors on a single chip. As another illustrative example, the processing unit may be a symmetric multi-processor system containing multiple processors of the same type. In yet another example, the processing unit may be embodied as or otherwise include one or more ASICs, FPGAs or the like. Thus, although the processing unit may be capable of executing a computer program to perform one or more functions, the processing unit of various examples may be capable of performing one or more functions without the aid of a computer program. In either instance, the processing unit may be appropriately programmed to perform functions or operations according to example implementations of the present disclosure.

The memory (50) is generally any piece of computer hardware that is capable of storing information such as, for example, data, computer programs (e.g., computer-readable program code (60)) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD, Blu-ray disk or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory (50), the processing unit (20) may also be connected to one or more interfaces for displaying, transmitting and/or receiving information. The interfaces may include one or more communications interfaces and/or one or more user interfaces. The communications interface(s) may be configured to transmit and/or receive information, such as to and/or from other computer(s), network(s), database(s) or the like. The communications interface may be configured to transmit and/or receive information by physical (wired) and/or wireless communications links. The communications interface(s) may include interface(s) (41) to connect to a network, such as using technologies such as cellular telephone, Wi-Fi, satellite, cable, digital subscriber line (DSL), fiber optics and the like. In some examples, the communications interface(s) may include one or more short-range communications interfaces (42) configured to connect devices using short-range communications technologies such as NFC, RFID, Bluetooth, Bluetooth LE, ZigBee, infrared (e.g., IrDA) or the like.

The user interfaces may include a display (30). The display may be configured to present or otherwise display information to a user, suitable examples of which include a liquid crystal display (LCD), light-emitting diode display (LED), plasma display panel (PDP) or the like. The user input interface(s) (11) may be wired or wireless, and may be configured to receive information from a user into the computer system (1), such as for processing, storage and/or display. Suitable examples of user input interfaces include a microphone, image or video capture device, keyboard or keypad, joystick, touch-sensitive surface (separate from or integrated into a touchscreen) or the like. In some examples, the user interfaces may include automatic identification and data capture (AIDC) technology (12) for machine-readable information. This may include barcode, radio frequency identification (RFID), magnetic stripes, optical character recognition (OCR), integrated circuit card (ICC), and the like. The user interfaces may further include one or more interfaces for communicating with peripherals such as printers and the like.

As indicated above, program code instructions may be stored in memory, and executed by processing unit that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, processing unit or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing unit or other programmable apparatus to configure the computer, processing unit or other programmable apparatus to execute operations to be performed on or by the computer, processing unit or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by processing unit, or storage of instructions in a computer-readable storage medium, supports combinations of operations for performing the specified functions. In this manner, a computer system (1) may include processing unit (20) and a computer-readable storage medium or memory (50) coupled to the processing circuitry, where the processing circuitry is configured to execute computer-readable program code (60) stored in the memory. It will also be understood that one or more functions, and combinations of functions, may be implemented by special purpose hardware-based computer systems and/or processing circuitry which perform the specified functions, or combinations of special purpose hardware and program code instructions.

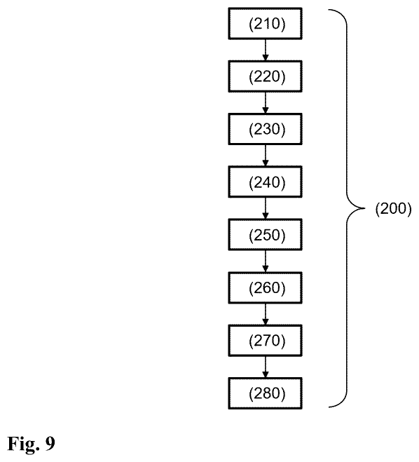

FIG. 9 shows an embodiment of the computer-implemented method of the present disclosure in the form of a flow chart. The method (200) comprises the steps:
(210) receiving a set of class-labelled medical images,
(220) clustering the medical images into a number of clusters according to morphological, structural, and/or textural aspects,
(230) determining a color scheme from each medical image,
(240) generating a text for each medical image, wherein the text of each medical image comprises:
   the class-label of the medical image,
   the color scheme of the medical image, and
   a cluster index, wherein the cluster index indicates which cluster the medical image was assigned to,
(250) generating a first training dataset based on the medical images and the texts,
(260) training a text-to-image model on the first training dataset to generate synthetic medical images based on text prompts,
(270) generating a second training dataset using the trained machine learning model, and
(280) outputting the second training dataset and/or using the second training dataset to train an image-utilizing machine learning model to perform a task based on one or more images.

1. A computer-implemented method comprising:
receiving a set of class-labelled medical images;
clustering the medical images into a number of clusters according to at least one of morphological, structural, or textural aspects;
determining a color scheme from each medical image;
generating a text for each medical image, wherein the text of each medical image comprises:
the class-label of the medical image;
the color scheme of the medical image; and
a cluster index, wherein the cluster index indicates which cluster the medical image was assigned to;
generating a first training dataset based on the medical images and the texts;
training a text-to-image model on the first training dataset to generate synthetic medical images based on text prompts;
generating a second training dataset using the trained machine learning model; and
outputting the second training dataset and using the second training dataset to train an image-utilizing machine learning model to perform a task based on one or more images.

2. The method of claim 1, wherein each medical image of the class-labelled medical images is a microscopic image, preferably a whole slide histological image of a tissue of a human body.

3. The method of claim 1, wherein each image of the class-labelled medical images is assigned to one of at least two classes, the at least two classes comprising at least one class representing medical images of an examination area of healthy examination subjects, and at least one class representing medical images of an examination area of examination subjects suffering from a disease.

4. The method of claim 1, wherein clustering the medical images comprises:
generating an embedding of each medical image; and
clustering the embeddings of the medical images.

5. The method of claim 4, wherein the embeddings are generated by an encoder of an autoencoder.

6. The method of claim 4, wherein the embeddings are generated by an image classifier, the image classifier being trained at least partially on the class-labelled medical images to assign each medical image to the respective class it is assigned to.

7. The method of claim 6, wherein the image classifier is a vision transformer.

8. The method of claim 1, wherein the medical images are images of cells and clustering is done on cell density or number of cells present in the medical images.

9. The method of claim 1, wherein the color scheme is determined based on color values of one of pixels, voxels, and doxels of the medical images.

10. The method of claim 1, wherein determining the color scheme comprises:
determining a mean color value for each medical image;
clustering the medical images according to their mean color value; and
assigning a cluster index to each medical image as the color scheme of the medical image.

11. The method of claim 1, wherein the text-to-image model is a diffusion model.

12. The method of claim 1, further comprising:
training the image-utilizing machine learning model at least partially on the second training dataset comprising a multitude of synthetic medical images to perform a task based on one or more images; and
using the image-utilizing machine learning model to classify a new medical image.

13. The method of claim 12, wherein the new medical image is assigned to one of two classes, a first class representing medical images of an examination area of healthy examination subjects, and a second class representing medical images of an examination area of examination subjects suffering from cancer.

14. A computer system comprising:
a processing unit; and
a memory storing an application program configured to perform, when executed by the processing unit, an operation, the operation comprising:
receiving a set of class-labelled medical images;
clustering the medical images into a number of clusters according to at least one of morphological, structural, or textural aspects;
determining a color scheme from each medical image;
generating a text for each medical image, wherein the text of each medical image comprises:
the class-label of the medical image;
the color scheme of the medical image; and
a cluster index, wherein the cluster index indicates which cluster the medical image was assigned to;
generating a first training dataset based on the medical images and the texts;
training a text-to-image model on the first training dataset to generate synthetic medical images based on text prompts;
generating a second training dataset using the trained machine learning model; and
outputting the second training dataset and using the second training dataset to train an image-utilizing machine learning model to perform a task based on one or more images.

15. A non-transitory computer readable storage medium having stored thereon software instructions that, when executed by a processing unit of a computer system, cause the computer system to execute the following steps:
receiving a set of class-labelled medical images;
clustering the medical images into a number of clusters according to at least one of morphological, structural, or textural aspects;
determining a color scheme from each medical image;
generating a text for each medical image, wherein the text of each medical image comprises:
the class-label of the medical image;
the color scheme of the medical image; and
a cluster index, wherein the cluster index indicates which cluster the medical image was assigned to;
generating a first training dataset based on the medical images and the texts;
training a text-to-image model on the first training dataset to generate synthetic medical images based on text prompts;
generating a second training dataset using the trained machine learning model; and
outputting the second training dataset and using the second training dataset to train an image-utilizing machine learning model to perform a task based on one or more images.
